(19) United States
(12) Patent Application Publication
(10) Pub. No.: US 2026/0036851 A1
(43) Pub. Date: Feb. 5, 2026

(54) LIQUID CRYSTAL ELEMENT

(71) Applicant: Japan Display Inc., Tokyo (JP)

(72) Inventors: Shunichi KIMURA, Tokyo (JP); Toshiharu MATSUSHIMA, Tokyo (JP)

(21) Appl. No.: 19/272,292

(22) Filed: Jul. 17, 2025

(30) Foreign Application Priority Data
Jul. 30, 2024 (JP) 2024-123042

(51) Int. Cl. G02F 1/1343

(52) U.S. Cl. CPC G02F 1/134309

(57) ABSTRACT

A liquid crystal element includes a first substrate, a liquid crystal layer, a second substrate, electrode sets each including a first electrode, a second electrode, a third electrode, and a fourth electrode, the first and second electrodes being disposed on the first substrate, the third and fourth electrodes being disposed on the second substrate. The first, second, third, and fourth electrodes extend in a first direction. In one of the electrode sets, the second electrode is disposed closer to the second substrate than the first electrode is, and overlaps a first end portion of the first electrode on a first end side in the second direction; the third electrode overlaps a second end portion of the first electrode on a second end side in the second direction; and the fourth electrode overlaps the second electrode. The electrode sets are arranged in the second direction. The first electrodes have light-blocking properties.

### CROSS-REFERENCE TO RELATED APPLICATION

This application claims the benefit of priority from Japanese Patent Application No. 2024-123042 filed on Jul. 30, 2024, the entire contents of which are incorporated herein by reference.

### BACKGROUND

### 1. Technical Field

What is disclosed herein relates to a liquid crystal element.

### 2. Description of the Related Art

Japanese Patent Application Laid-open Publication No. 2015-174551 (JP-A-2015-174551) discloses a headlight capable of controlling light distribution. The headlight of JP-A-2015-174551 reflects light from a light source by using a mirror, converges the reflected light with a lens, and projects light toward the front side of the vehicle. The direction of light projection is adjusted by adjusting the angle of the mirror.

Japanese Patent Application Laid-open Publication No. 2023-63255 (JP-A-2023-63255) discloses an illumination device including a lamp unit including a light source, and an arm coupled to the lamp unit. The arm includes a first arm and a second arm coupled to each other in a relatively rotatable manner. The lamp unit and the second arm are coupled to each other in a relatively rotatable manner. The emission direction of light from the light source is adjusted by adjusting the angle between the first and second arms and the angle between the lamp unit and the second arm.

In a device capable of adjusting the emission direction of light as in JP-A-2015-174551 or JP-A-2023-63255, the emission direction of light is adjusted through operation of a movable part in a mechanism including a plurality of mechanical components. The configuration of such a device is desired to be simplified.

For the foregoing reasons, there is a need for a liquid crystal element capable of easily adjusting the emission direction of light.

### SUMMARY

According to an aspect, a liquid crystal element includes: a first substrate and a second substrate facing each other; a plurality of electrode sets each including a first electrode, a second electrode, a third electrode, and a fourth electrode, the first electrode and the second electrode being disposed on the first substrate, the third electrode and the fourth electrode being disposed on the second substrate; and a liquid crystal layer positioned between the first substrate and the second substrate. The first electrodes, the second electrodes, the third electrodes, and the fourth electrodes extend in a first direction. A length of each of the first electrodes is longer than a length of each of the second electrodes, a length of each of the third electrodes, and a length of each of the fourth electrodes in a second direction orthogonal to the first direction. In one of the electrode sets, the second electrode is disposed closer to the second substrate than the first electrode is, and overlaps, in plan view, a first end portion of the first electrode on a first end side in the second direction; the third electrode overlaps, in plan view, a second end portion of the first electrode on a second end side in the second direction; and the fourth electrode overlaps the second electrode in plan view. The electrode sets are arranged in the second direction. The first electrodes have light-blocking properties.

### BRIEF DESCRIPTION OF THE DRAWINGS

FIG. 1 is a conceptual diagram of a liquid crystal element according to an embodiment of the present disclosure;

FIG. 2 is a plan view of the liquid crystal element according to the embodiment of the present disclosure;

FIG. 3 is a sectional view of the liquid crystal element along line III-III illustrated in FIG. 2;

FIG. 4 is a plan view illustrating an arrangement of first electrodes and second electrodes;

FIG. 5 is a plan view illustrating an arrangement of third electrodes and fourth electrodes;

FIG. 6 is a diagram illustrating the phase difference of emission light passing through a liquid crystal layer of the liquid crystal element illustrated in FIG. 3;

FIG. 7 is a sectional view of a liquid crystal element according to a modification of the embodiment of the present disclosure; and

FIG. 8 is a plan view illustrating an arrangement of first electrodes, second electrodes, and fifth electrodes illustrated in FIG. 7.

### DETAILED DESCRIPTION

An embodiment of the present disclosure is described below with reference to the drawings. Contents described below in the embodiments do not limit the present disclosure. Components described below include those that could be easily thought of by the skilled person in the art and those identical in effect. Components described below may be combined as appropriate.

What is disclosed herein is only an example, and any modifications that can be easily conceived by those skilled in the art while maintaining the main purpose of the present disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

In this disclosure, when an element is described as being “on” another element, the element can be directly on the other element, or there can be one or more elements between the element and the other element.

A first direction D1 and a second direction D2 illustrated in the drawings correspond to directions parallel to the plate surfaces of substrates included in a liquid crystal element 1 to be described later. The first direction D1 and the second direction D2 correspond to directions along sides of the liquid crystal element 1. In the first direction D1, a side indicated by an arrow is a positive D1 side, and a side opposite to the positive D1 side is a negative D1 side. In the second direction D2, a side indicated by an arrow is a positive D2 side, and a side opposite to the positive D2 side is a negative D2 side.

A third direction D3 corresponds to the thickness direction of the liquid crystal element 1. In the third direction D3, a side indicated by an arrow is a positive D3 side, and a side opposite to the positive D3 side is a negative D3 side. The positive D3 side in the third direction D3 corresponds to the front surface side of the liquid crystal element 1, and the negative D3 side in the third direction D3 corresponds to the back surface side of the liquid crystal element 1. In the present specification, “plan view” is the view of the liquid crystal element 1 in the third direction D3. The first direction D1, the second direction D2, and the third direction D3 are exemplary, and the present disclosure is not limited to these directions.

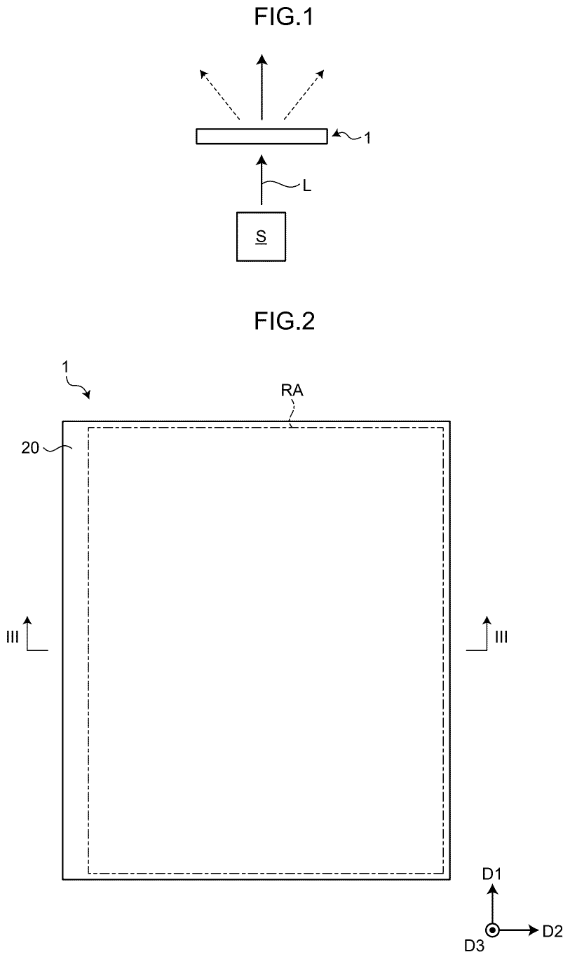

FIG. 1 is a conceptual diagram of the liquid crystal element 1 according to an embodiment of the present disclosure. The liquid crystal element 1 is a refractive plate that refracts light. Emission light L emitted from a light source S enters the liquid crystal element 1. The light source S is, for example, an illumination device such as a vehicle headlight or a spotlight.

When no voltage is applied, the liquid crystal element 1 transmits the emission light L as illustrated with the solid arrow without changing the direction (emission direction) in which the emission light L travels. When voltage is applied, the liquid crystal element 1 refracts the emission light L in one of two directions illustrated with the dashed arrows (to be described later in detail).

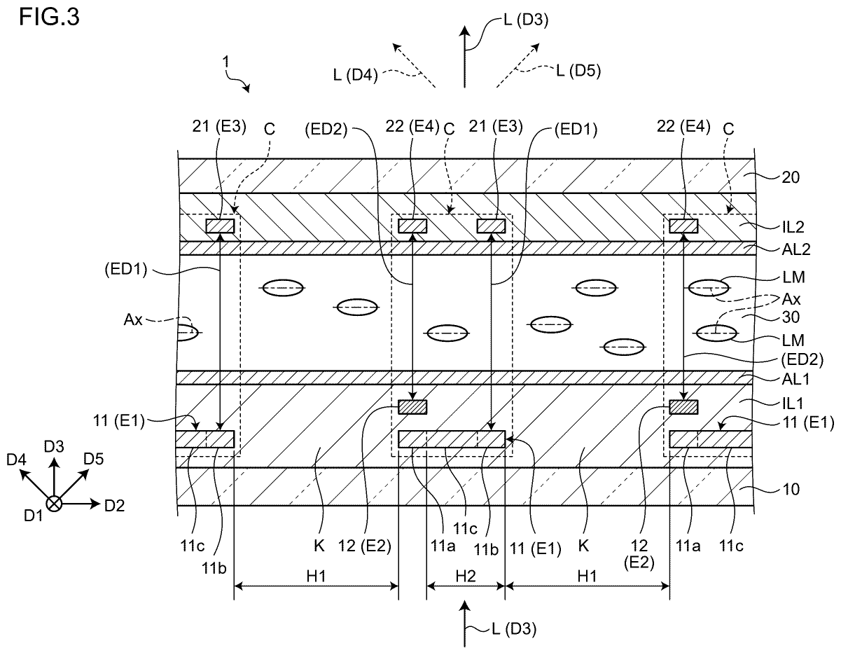

FIG. 2 is a plan view of the liquid crystal element 1 according to the embodiment of the present disclosure. FIG. 3 is a sectional view of the liquid crystal element 1 along line III-III illustrated in FIG. 2. The sectional view of the liquid crystal element 1 illustrated in FIG. 3 illustrates a sectional shape of the liquid crystal element 1 along a plane orthogonal to the first direction D1.

The liquid crystal element 1 includes a first substrate 10, a second substrate 20, and a liquid crystal layer 30.

The first substrate 10 and the second substrate 20 face each other. The first substrate 10 and the second substrate 20 have a light-transmitting property. The first substrate 10 and the second substrate 20 are, for example, glass substrates, resin substrates, or resin films.

A plurality of first electrodes 11, a plurality of second electrodes 12, a first insulating layer IL1, and a first alignment film AL1 are disposed on the first substrate 10.

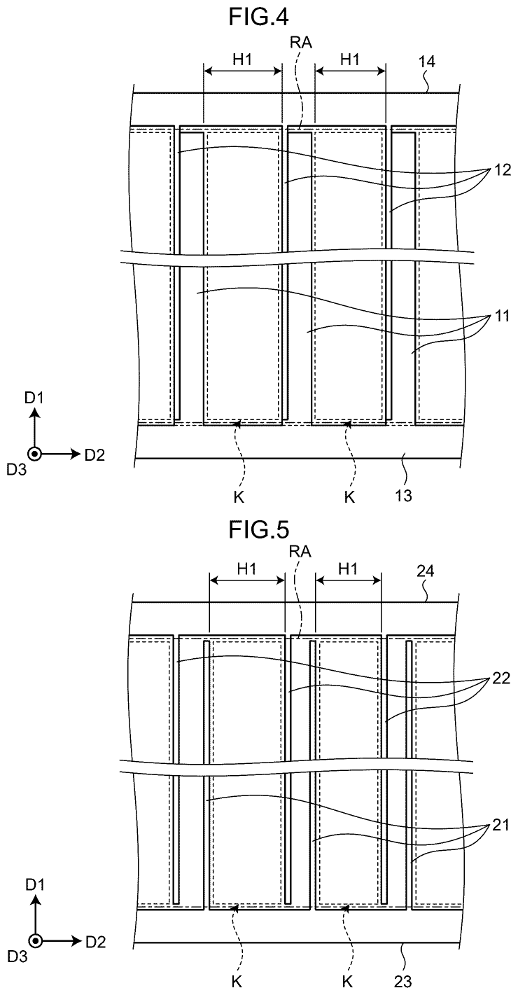

FIG. 4 is a plan view illustrating an arrangement of the first electrodes 11 and the second electrodes 12. The first electrodes 11 and the second electrodes 12 extend in the first direction D1.

As illustrated in FIGS. 3 and 4, the first electrodes 11 and the second electrodes 12 are arranged in the second direction D2. In the second direction D2, the length of each first electrode 11 is longer than the length of each second electrode 12.

The second electrodes 12 are disposed closer to the second substrate 20 than the first electrodes 11 are. In plan view, one of the second electrodes 12 overlaps a first end portion 11a of one of the first electrodes 11 on a first end side (negative D2 side) in the second direction D2. In other words, the first end portion 11a is a portion of the first electrode 11, which overlaps the second electrode 12 in plan view. In plan view, the first electrodes 11 and the second electrodes 12 overlap a refraction region RA in which the emission light L is refracted.

As illustrated in FIG. 4, the liquid crystal element 1 further includes a first trunk electrode 13 and a second trunk electrode 14 that are disposed on the first substrate 10.

The first trunk electrode 13 is positioned on the outer side (negative D1 side) of the refraction region RA in plan view and extends in the second direction D2. The first trunk electrode 13 is electrically coupled to the first electrodes 11. The first trunk electrode 13 is integrated with the first electrodes 11. The first trunk electrode 13 is electrically insulated from the second electrodes 12.

The second trunk electrode 14 is positioned on the outer side (positive D1 side) of the refraction region RA in plan view and extends in the second direction D2. The second trunk electrode 14 is electrically coupled to the second electrodes 12. The second trunk electrode 14 is integrated with the second electrodes 12. The second trunk electrode 14 is electrically insulated from the first electrodes 11.

The first and second trunk electrodes 13 and 14 are electrically coupled to a non-illustrated control circuit. The control circuit applies voltage to the first electrodes 11 through the first trunk electrode 13. The control circuit applies voltage to the second electrodes 12 through the second trunk electrode 14.

The first insulating layer IL1 illustrated in FIG. 3 electrically insulates the first trunk electrode 13 and the second trunk electrode 14 from each other. The first insulating layer IL1 also electrically insulates the first electrodes 11 and the second electrodes 12 from each other.

The first alignment film AL1 is disposed on the positive D3 side of the first electrodes 11 and the second electrodes 12. The first alignment film AL1 is disposed in a state of being separated from the first electrode 11 and the second electrode 12. The first alignment film AL1 may contact the first electrodes 11 and the second electrodes 12.

A plurality of third electrodes 21, a plurality of fourth electrodes 22, a second insulating layer IL2, and a second alignment film AL2 are disposed on the second substrate 20.

FIG. 5 is a plan view illustrating an arrangement of the third electrodes 21 and the fourth electrodes 22. The third electrodes 21 and the fourth electrodes 22 extend in the first direction D1.

As illustrated in FIGS. 3 and 5, the third electrodes 21 and the fourth electrodes 22 are alternately arranged in the second direction D2. The third electrodes 21 and the fourth electrodes 22 face each other in the second direction D2.

In the second direction D2, the length of each third electrode 21 and the length of each fourth electrode 22 are equal to the length of each second electrode 12. Accordingly, in the second direction D2, the length of each first electrode 11 is longer than the length of each second electrode 12, the length of each third electrode 21, and the length of each fourth electrode 22.

In plan view, one of the third electrodes 21 overlaps a second end portion 11b of one of the first electrodes 11 on a second end side (positive D2 side) in the second direction D2. In other words, the second end portion 11b is a portion of the first electrode 11, which overlaps the third electrode 21 in plan view.

Hereinafter, a portion of each first electrode 11 between the first end portion 11a and the second end portion 11b is referred to as intermediate portion 11c. The first end portion 11a, the second end portion 11b, and the intermediate portion 11c are integrated. In the second direction D2, the length of the first end portion 11a is equal to the length of the second end portion 11b. In the second direction D2, the length of the intermediate portion 11c is equal to or longer than the length of the first end portion 11a. The length of the intermediate portion 11c may be shorter than the length of the first end portion 11a.

One of the fourth electrodes 22 overlaps one of the second electrodes 12 in plan view. Accordingly, the one fourth electrode 22 overlaps the first end portion 11a of one of the first electrodes 11 in plan view. In plan view, the third electrodes 21 and the fourth electrodes 22 overlap the refraction region RA in which the emission light L is refracted.

As illustrated in FIG. 5, the liquid crystal element 1 further includes a third trunk electrode 23 and a fourth trunk electrode 24 that are disposed on the second substrate 20.

The third trunk electrode 23 is positioned on the outer side (negative D1 side) of the refraction region RA in plan view and extends in the second direction D2. The third trunk electrode 23 is electrically coupled to the third electrodes 21. The third trunk electrode 23 is integrated with the third electrodes 21. The third trunk electrode 23 is electrically insulated from the fourth electrodes 22.

The fourth trunk electrode 24 is positioned on the outer side (positive D1 side) of the refraction region RA in plan view and extends in the second direction D2. The fourth trunk electrode 24 is electrically coupled to the fourth electrodes 22. The fourth trunk electrode 24 is integrated with the fourth electrodes 22. The fourth trunk electrode 24 is electrically insulated from the third electrodes 21.

The third and fourth trunk electrodes 23 and 24 are electrically coupled to a non-illustrated control circuit. The control circuit applies voltage to the third electrodes 21 through the third trunk electrodes 23. The control circuit applies voltage to the fourth electrodes 22 through the fourth trunk electrodes 24.

The material of the first electrodes 11, the second electrodes 12, the first trunk electrode 13, the second trunk electrode 14, the third electrodes 21, the fourth electrodes 22, the third trunk electrode 23, and the fourth trunk electrode 24 is a conductive material such as a molybdenum tungsten alloy (MoW) or TAT (Ti/Al/Ti) in which titanium (Ti) and aluminum (Al) are stacked. In this case, the second electrodes 12, the first trunk electrode 13, the second trunk electrode 14, the third electrodes 21, the fourth electrodes 22, the third trunk electrode 23, and the fourth trunk electrode 24 have light-blocking properties.

The material of the second electrodes 12, the first trunk electrode 13, the second trunk electrode 14, the third electrodes 21, the fourth electrodes 22, the third trunk electrode 23, and the fourth trunk electrode 24 may be a conductive material having a light-transmitting property, such as indium tin oxide (ITO), indium zinc oxide (IZO), indium gallium oxide (IGO), or indium gallium zinc oxide (IGZO). In this case, the second electrodes 12, the first trunk electrode 13, the second trunk electrode 14, the third electrodes 21, the fourth electrodes 22, the third trunk electrode 23, and the fourth trunk electrode 24 have no light-blocking properties.

In other words, at least the first electrodes 11 among the first electrodes 11, the second electrodes 12, the third electrodes 21, and the fourth electrodes 22 have light-blocking properties.

As illustrated in FIG. 3, a first length H1 in the second direction D2 between two adjacent first electrodes 11 in the second direction D2 among the first electrodes 11 is equal to or longer than a second length H2 in the second direction D2 of each of portions of the first electrodes 11 excluding the first end portions 11a (in other words, portions including both the second end portions 11b and the intermediate portions 11c).

One of the first electrodes 11, and one second electrode 12, one third electrode 21, and one fourth electrode 22 that overlap the one first electrode 11 in plan view constitute one electrode set C. Accordingly, the liquid crystal element 1 includes a plurality of electrode sets C each including a first electrode 11 and a second electrode 12, which are disposed on the first substrate 10, and a third electrode 21 and a fourth electrode 22, which are disposed on the second substrate 20.

The electrode sets C are arranged in the second direction D2. A length between two adjacent the electrode sets C in the second direction D2 among the electrode sets C corresponds to the first length H1.

The first electrodes 11 have light-blocking properties as described above. Accordingly, in the refraction region RA, a space between two adjacent electrode sets C in the second direction D2 among the electrode sets C corresponds to an opening part K through which light is transmitted (refer to FIGS. 3 and 4). The first length H1 is equal to or longer than the second length H2 as described above. This allows the opening part K to be larger, thereby improving the efficiency of use of the emission light L.

The second insulating layer IL2 electrically insulates the third trunk electrode 23 and the fourth trunk electrode 24 from each other. The second insulating layer IL2 also electrically insulates the third electrodes 21 and the fourth electrodes 22 from each other.

The second alignment film AL2 is disposed on the negative D3 side of the third electrodes 21 and the fourth electrodes 22. The second alignment film AL2 is disposed in a state of being separated from the third electrodes 21 and the fourth electrodes 22. The second alignment film AL2 may contact the third electrodes 21 and the fourth electrodes 22.

The liquid crystal layer 30 is positioned between the first substrate 10 and the second substrate 20. The liquid crystal layer 30 is sandwiched between the first alignment film AL1 and the second alignment film AL2. The first alignment film AL1 and the second alignment film AL2 induce a predetermined alignment (initial alignment) of liquid crystal molecules LM contained in the liquid crystal layer 30 when no voltage is applied to the liquid crystal element 1. The initial alignment of the liquid crystal molecules LM is in such a direction (horizontal alignment) that a long axis Ax of each liquid crystal molecule LM is orthogonal to the third direction D3. The alignment direction of the first alignment film AL1 and the alignment direction of the second alignment film AL2 are parallel to each other in plan view.

The liquid crystal element 1 is an electrically controlled birefringence (ECB) liquid crystal element. However, the liquid crystal element 1 is not limited to an ECB liquid crystal element.

The following describes operation when the liquid crystal element 1 refracts the emission light L from the light source S. The liquid crystal element 1 refracts the emission light L when voltage is applied to the first electrodes 11, the second electrodes 12, the third electrodes 21, and the fourth electrodes 22 by a control circuit. The emission light L enters the liquid crystal element 1 in the third direction D3 from the back surface of the first substrate 10. A reference sign inside parentheses of the emission light L in the drawings indicates the direction in which the emission light L travels. In FIG. 3, the emission light L from the liquid crystal element 1 is illustrated on the positive D3 side of the liquid crystal element 1.

When no voltage is applied to the first electrodes 11, the second electrodes 12, the third electrodes 21, and the fourth electrodes 22, the alignment states of all liquid crystal molecules LM included in the liquid crystal layer 30 are in initial alignment (horizontal alignment) and all liquid crystal molecules LM have the same tilt degree. Thus, the phase change amount of the emission light L passing through the liquid crystal layer 30 is equal at all portions of the liquid crystal layer 30, and no phase difference occurs to the emission light L. Accordingly, the liquid crystal element 1 emits the emission light L without refraction. Specifically, as illustrated in FIG. 3, the liquid crystal element 1 causes the emission light L incident in the third direction D3 to exit therefrom in the third direction D3 without refraction,.

When the liquid crystal element 1 refracts the emission light L from the light source S, voltage is applied to the first electrodes 11, the second electrodes 12, the third electrodes 21, and the fourth electrodes 22 such that the magnitude (ED1) of a first potential difference between the potential (E1) of the first electrodes 11 and the potential (E3) of the third electrodes 21 is different from the magnitude (ED2) of a second potential difference between the potential (E2) of the second electrodes 12 and the potential (E4) of the fourth electrodes 22. Hereinafter, the first electrodes 11, the second electrodes 12, the third electrodes 21, and the fourth electrodes 22 are simply referred to as “electrodes” when described without distinction. A reference sign inside parentheses of the emission light L in the drawings indicates the direction in which the emission light L travels.

Specifically, when the liquid crystal element 1 refracts the emission light L such that the light travels in a fourth direction D4 tilted to the negative D2 side relative to the third direction D3, voltage is applied to the electrodes such that the magnitude of the second potential difference is larger than the magnitude of the first potential difference (ED1<ED2).

When voltage is applied to the electrodes, an electric field acts on the liquid crystal layer 30, causing the liquid crystal molecules LM to tilt. As the magnitude of the potential difference in the third direction D3 increases in the liquid crystal layer 30, the tilt degree of the liquid crystal molecules LM increases (the angles of the long axes Ax of the liquid crystal molecules LM relative to the second direction D2 increase).

As the tilt degree of the liquid crystal molecules LM increases, the phase of the emission light L passing through the liquid crystal layer 30 advances. In other words, as the magnitude of the potential difference in the third direction D3 in the liquid crystal layer 30 increases, the phase of the emission light L advances.

When the liquid crystal element 1 refracts the emission light L such that the light travels in the fourth direction D4, the magnitude (ED2) of the second potential difference is larger than the magnitude (ED1) of the first potential difference as described above. Accordingly, the tilt degree of the liquid crystal molecules LM between the second and fourth electrodes 12 and 22 is larger than the tilt degree of the liquid crystal molecules LM between the first and third electrodes 11 and 21. At each opening part K, from the negative D2 side toward the positive D2 side in the second direction D2, the magnitude of the potential difference in the third direction D3 and the tilt degree of the liquid crystal molecules LM increase.

Voltage is applied to the first electrodes 11, the second electrodes 12, the third electrodes 21, and the fourth electrodes 22 such that the potential of the first electrodes 11 is different from the potential of the second electrodes 12 and the potential of the third electrodes 21 is different from the potential of the fourth electrodes 22. Accordingly, potential difference is generated between the potential of the first electrodes 11 and the potential of the second electrodes 12. Potential difference is generated between the potential of the third electrodes 21 and the potential of the fourth electrodes 22.

When the liquid crystal element 1 refracts the emission light L such that the light travels in the fourth direction D4, voltage is applied to the electrodes such that, for example, the potential (E2) of the second electrodes 12 is larger than the potential (E1) of the first electrodes 11 (E1<E2) and the potential (E3) of the third electrodes 21 is larger than the potential (E4) of the fourth electrodes 22 (E4<E3).

In this case, for example, the potential (E3) of the third electrodes 21 is larger than the potential (E1) of the first electrodes 11 (E1<E3), the potential (E1) of the first electrodes 11 is larger than the potential (E4) of the fourth electrodes 22 (E4<E1), and the potential (E2) of the second electrodes 12 is equal to the potential (E3) of the third electrodes 21 (E2=E3). Thus, the electrode potential relation in this case is expressed by Expression (1) below.

E4<E1<E2=E3 (1)

Moreover, in this case, the potential (E2) of the second electrodes 12 and the potential (E4) of the fourth electrodes 22 have the same magnitude but opposite polarities as expressed by Expression (2).

E2=(−1)×E4 (2)

When the electrode potential relation satisfies the relation of Expressions (1) and (2), the electrode potential can be controlled by a column inversion driving method in which the polarity of the electrode potential is periodically inverted. The electrode potential relation is not limited to the relation of Expressions (1) and (2).

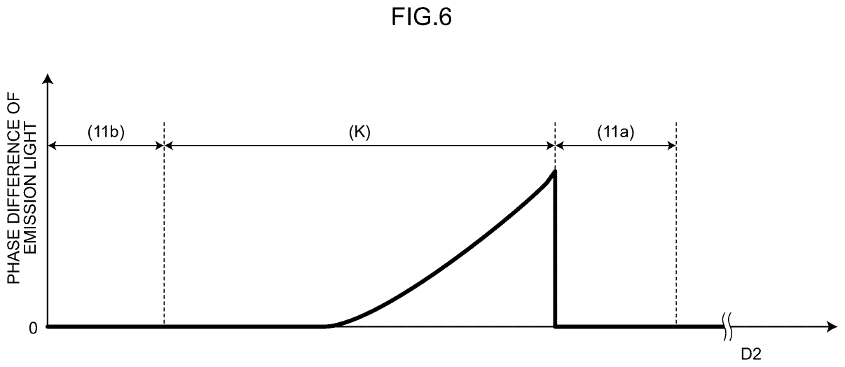

FIG. 6 is a diagram illustrating the phase difference of the emission light L passing through the liquid crystal layer 30 of the liquid crystal element 1 illustrated in FIG. 3. FIG. 6 illustrates a case where the electrode potential relation is the relation represented by Expressions (1) and (2) and voltage is applied to the electrodes such that the magnitude (ED2) of the second potential difference is approximately twice the magnitude (ED1) of the first potential difference.

The vertical axis in FIG. 6 represents the phase difference of the emission light L. The horizontal axis in FIG. 6 represents the position in the second direction D2 in the liquid crystal layer 30. In FIG. 6, the region of “(11a)” represents the region of the first end portion 11a of a first electrode 11 in the second direction D2, and the region of “(11b)” represents the region of the second end portion 11b of a first electrode 11 and a second electrode 12 in the second direction D2. Accordingly, a region between “(11a)” and “(11b)” in FIG. 6 corresponds to the region of an opening part K. FIG. 6 illustrates, with a solid line, the phase difference of the emission light L passing through the liquid crystal layer 30 when the phase of the emission light L passing through an end of the opening part K on the negative D2 side is assumed as a reference (zero).

Since the magnitude of the second potential difference is larger than the magnitude of the first potential difference (ED1<ED2), the phase difference increases from the negative D2 side toward the positive D2 side in the second direction D2 at the opening part K. In other words, the phase of the emission light L passing through the liquid crystal layer 30 advances from the negative D2 side toward the positive D2 side in the second direction D2 at the opening part K. Accordingly, the emission light L is refracted to be emitted in the fourth direction D4.

In a case where the liquid crystal element 1 refracts the emission light L such that the light travels in a fifth direction D5 tilted to the positive D2 side relative to the third direction D3, voltage is applied to the electrodes such that the magnitude (ED1) of the first potential difference is larger than the magnitude (ED2) of the second potential difference (ED2<ED1). In this case, voltage is applied to the first electrodes 11, the second electrodes 12, the third electrodes 21, and the fourth electrodes 22 such that the potential of the first electrodes 11 is different from the potential of the second electrodes 12 and the potential of the third electrodes 21 is different from the potential of the fourth electrodes 22. In this case, the electrode potential relation may be the relation represented by Expressions (3) and (4) below.

E3<E2<E1=E4 (3)

E1=(−1)×E3 (4)

When the electrode potential relation satisfies the relation of Expressions (3) and (4), the electrode potential can be controlled by the column inversion driving method in which the polarity of the electrode potential is periodically inverted. The electrode potential relation is not limited to the relation of Expressions (3) and (4).

Since the magnitude of the first potential difference is larger than the magnitude of the second potential difference (ED2<ED1), the phase difference in the third direction D3 increases from the positive D2 side toward the negative D2 side in the second direction D2 at the opening part K. In other words, the phase of the emission light L passing through the liquid crystal layer 30 advances from the positive D2 side toward the negative D2 side in the second direction D2 at the opening part K. Accordingly, the emission light L is refracted to be emitted in the fifth direction D5.

In this manner, the liquid crystal element 1 can easily control the emission direction of the emission light L by controlling voltage applied to the electrodes.

Preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

For example, voltage may be applied to the electrodes such that the potential of the third electrodes 21 is equal to the potential of the fourth electrodes 22.

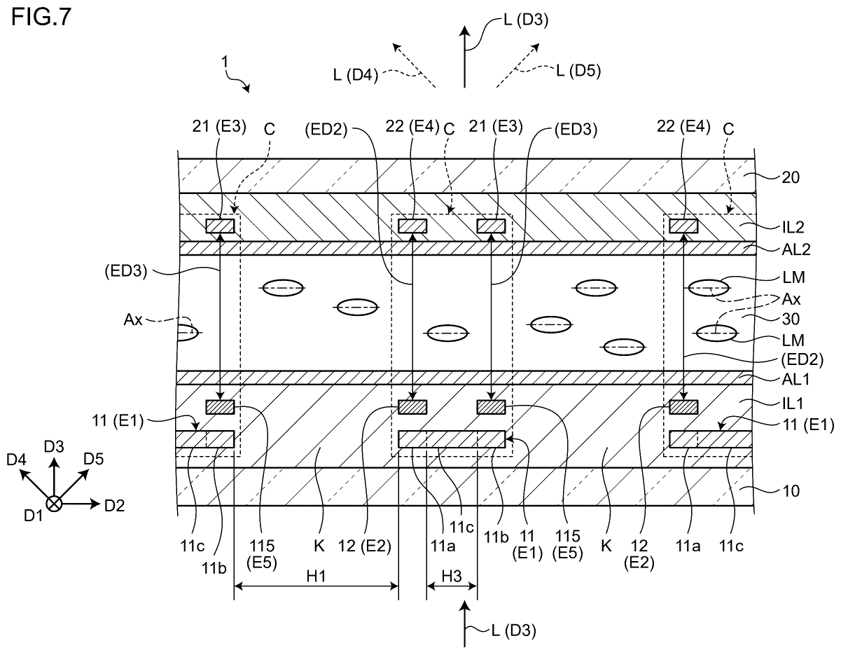

FIG. 7 is a sectional view of the liquid crystal element 1 according to a modification of the embodiment of the present disclosure. The following describes the liquid crystal element 1 of the present modification with a focus on its difference from the liquid crystal element 1 of the above-described embodiment. In the present modification, the liquid crystal element 1 further includes a plurality of fifth electrodes 115 disposed on the first substrate 10. Each of the electrode sets C includes one fifth electrode 115.

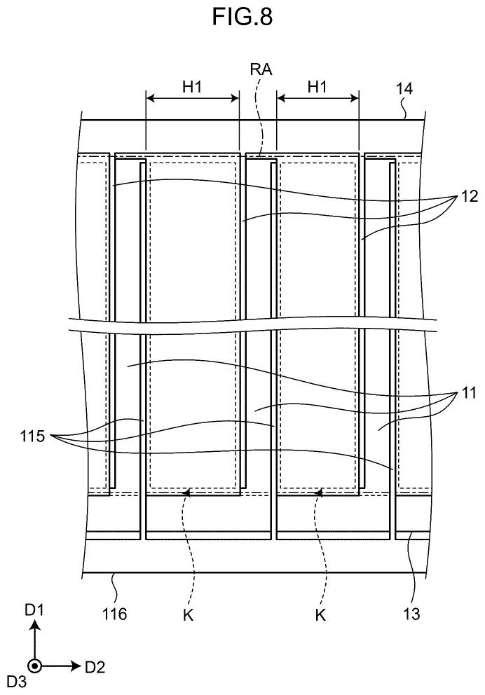

FIG. 8 is a plan view illustrating an arrangement of the first electrodes 11, the second electrodes 12, and the fifth electrodes 115 illustrated in FIG. 7. The fifth electrodes 115 extend in the first direction D1.

As illustrated in FIGS. 7 and 8, the second electrodes 12 and the fifth electrodes 115 are alternately arranged in the second direction D2. The second electrodes 12 and the fifth electrodes 115 face each other in the second direction D2.

In the second direction D2, the length of each fifth electrode 115 is equal to the length of each second electrode 12. Accordingly, in the second direction D2, the length of each first electrode 11 is longer than the length of each fifth electrode 115.

The fifth electrodes 115 are disposed closer to the second substrate 20 than the first electrodes 11 are. In one of the electrode sets C, the fifth electrode 115 overlaps the third electrode 21 in plan view. Accordingly, the fifth electrodes 115 overlaps the second end portion 11b of the first electrode 11 in plan view. The fifth electrodes 115 overlap the refraction region RA in which the emission light L is refracted in plan view.

As illustrated in FIG. 8, the liquid crystal element 1 further includes a fifth trunk electrode 116 disposed on the first substrate 10. The fifth trunk electrode 116 is positioned on the outer side (negative D1 side) of the refraction region RA in plan view and extends in the second direction D2. The fifth trunk electrode 116 is electrically coupled to the fifth electrodes 115. The fifth trunk electrode 116 is integrated with the fifth electrodes 115. The fifth trunk electrode 116 is electrically insulated from the first electrodes 11 and the second electrodes 12.

The fifth trunk electrode 116 is electrically coupled to a control circuit. The control circuit applies voltage to the fifth electrodes 115 through the fifth trunk electrode 116. The first insulating layer IL1 electrically insulates the first trunk electrode 13 and the second trunk electrode 14 from the fifth trunk electrode 116. The first insulating layer IL1 also electrically insulates the first electrodes 11 and the second electrodes 12 from the fifth electrodes 115. The material of the fifth electrodes 115 and the fifth trunk electrode 116 is the same as the material of the second electrodes 12.

As illustrated in FIG. 7, the first length H1 is equal to or longer than a third length H3 in the second direction D2 of each of portions (in other words, the intermediate portions 11c) of the first electrodes 11 excluding the first end portions 11a and the second end portions 11b. This allows the opening part K to be larger, thereby improving the efficiency of use of the emission light L.

The following describes operation when the liquid crystal element 1 of the present modification refracts the emission light L from the light source S.

When the liquid crystal element 1 refracts the emission light L from the light source S, voltage is applied to the second electrodes 12, the third electrodes 21, the fourth electrodes 22, and the fifth electrodes 115 such that the magnitude (ED2) of the second potential difference between the potential (E2) of the second electrodes 12 and the potential (E4) of the fourth electrodes 22 is different from the magnitude (ED3) of a third potential difference between the potential (E3) of the third electrodes 21 and the potential (E5) of the fifth electrodes 115. Hereinafter, the first electrodes 11, the second electrodes 12, the third electrodes 21, the fourth electrodes 22, and the fifth electrodes 115 are simply referred to as electrodes when described without distinction.

In a case where voltage is applied to the electrodes such that the magnitude of the second potential difference is larger than the magnitude of the third potential difference (ED3<ED2), the phase of the emission light L passing through the liquid crystal layer 30 advances from the negative D2 side toward the positive D2 side in the second direction D2 at the opening part K. Accordingly, the emission light L is refracted to exit in the fourth direction D4.

In this case, voltage may be applied to the second electrodes 12, the third electrodes 21, the fourth electrodes 22, and the fifth electrodes 115 such that the potential of the second electrodes 12 is different from the potential of the fifth electrodes 115 and the potential of the third electrodes 21 is different from the potential of the fourth electrodes 22. In this case, the electrode potential relation may be the relation expressed by Expressions (5) and (6) below.

E4<E5<E2=E3 (5)

E2=(−1)×E4 (6)

When the electrode potential relation satisfies the relation of Expressions (5) and (6), the electrode potential can be controlled by the column inversion driving method in which the polarity of the electrode potential is periodically inverted.

In a case where voltage is applied to the electrodes such that the magnitude of the third potential difference is larger than the magnitude of the second potential difference (ED2<ED3), the phase of the emission light L passing through the liquid crystal layer 30 advances from the positive D2 side toward the negative D2 side in the second direction D2 at the opening part K. Accordingly, the emission light L is refracted to exit in the fifth direction D5.

In this case, the electrode potential relation may be the relation represented by Expressions (7) and (8) below.

E3<E2<E5=E4 (7)

E5=(−1)×E3 (8)

When the electrode potential relation satisfies the relation of Expressions (7) and (8), the electrode potential can be controlled by the column inversion driving method in which the polarity of the electrode potential is periodically inverted.

In both cases where voltage is applied to the electrodes such that the magnitude of the second potential difference is larger than the magnitude of the third potential difference (ED3<ED2) and where voltage is applied to the electrodes such that the magnitude of the third potential difference is larger than the magnitude of the second potential difference (ED2<ED3), the potential (E1) of the first electrodes 11 is equal to the potential (E5) of the fifth electrodes 115. In both such cases, the potential (E1) of the first electrodes 11 may be a potential between the potential (E2) of the second electrodes 12 and the potential (E5) of the fifth electrodes 115. The phase difference in the second direction D2 at the opening part K can be controlled by the potential of the first electrodes 11.

It should be understood that the present disclosure provides any other effects achieved by aspects described above in the above-described embodiments, such as effects that are clear from the description of the present specification or effects that could be thought of by the skilled person in the art as appropriate.

What is claimed is:

1. A liquid crystal element comprising:
a first substrate and a second substrate facing each other;
a plurality of electrode sets each including a first electrode, a second electrode, a third electrode, and a fourth electrode, the first electrode and the second electrode being disposed on the first substrate, the third electrode and the fourth electrode being disposed on the second substrate; and
a liquid crystal layer positioned between the first substrate and the second substrate, wherein
the first electrodes, the second electrodes, the third electrodes, and the fourth electrodes extend in a first direction,
a length of each of the first electrodes is longer than a length of each of the second electrodes, a length of each of the third electrodes, and a length of each of the fourth electrodes in a second direction orthogonal to the first direction,
in one of the electrode sets,
the second electrode is disposed closer to the second substrate than the first electrode is, and overlaps, in plan view, a first end portion of the first electrode on a first end side in the second direction,
the third electrode overlaps, in plan view, a second end portion of the first electrode on a second end side in the second direction, and
the fourth electrode overlaps the second electrode in plan view,
the electrode sets are arranged in the second direction, and
the first electrodes have light-blocking properties.

2. The liquid crystal element according to claim 1, wherein a first length in the second direction between two adjacent first electrodes in the second direction among the first electrodes is equal to or longer than a second length in the second direction of each of portions of the first electrodes excluding the first end portions.

3. The liquid crystal element according to claim 1, wherein voltage is applied to the first electrodes, the second electrodes, the third electrodes, and the fourth electrodes such that magnitude of a first potential difference between a potential of the first electrodes and a potential of the third electrodes is different from magnitude of a second potential difference between a potential of the second electrodes and a potential of the fourth electrodes.

4. The liquid crystal element according to claim 1, wherein voltage is applied to the first electrodes, the second electrodes, the third electrodes, and the fourth electrodes such that a potential of the first electrodes is different from a potential of the second electrodes and a potential of the third electrodes is different from a potential of the fourth electrodes.

5. The liquid crystal element according to claim 1, wherein
each of the electrode sets further includes a fifth electrode disposed on the first substrate and extending in the first direction, and
in one of the electrode sets, the fifth electrode is disposed closer to the second substrate than the first electrode is, and overlaps the third electrode in plan view.

6. The liquid crystal element according to claim 5, wherein a first length in the second direction between two adjacent first electrodes in the second direction among the first electrodes is equal to or longer than a third length in the second direction of each of portions of the first electrodes excluding the first end portions and the second end portions.

7. The liquid crystal element according to claim 5, wherein voltage is applied to the second electrodes, the third electrodes, the fourth electrodes, and the fifth electrodes such that magnitude of a second potential difference between a potential of the second electrodes and a potential of the fourth electrodes is different from magnitude of a third potential difference between a potential of the third electrodes and a potential of the fifth electrodes.
